(19) United States
(12) Patent Application Publication
(10) Pub. No.: US 2004/0027220 A1
(43) Pub. Date: Feb. 12, 2004

(54) Half-cycle transductor with a magnetic core, use of half-cycle transductors and method for producing magnetic cores for half-cycle transductors

(76) Inventors: Wulf Gunther, Maintal (DE); Roman Klinger, Hanau (DE); Werner Loges, Langenselbold (DE); Jorg Petzold, Bruchkobel (DE)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/380,714

(22) PCT Filed: Sep. 7, 2001
(86) PCT No.: PCT/EP01/10362

(30) Foreign Application Priority Data
Sep. 13, 2000 (DE) 100-45-705..3

(51) Int. Cl. H01F 3/00; H01F 7/06

(52) U.S. Cl. 335/297; 29/602.1

(57) ABSTRACT

The invention relates to a transductor regulator with a magnetic core which is made up of a nanocrystalline alloy which is almost free of magnetorestriction. The core has as low cyclic magnetization losses as possible and as rectangular a hysterisis cycle as possible. Said alloy has the composition: FeaCobCucM′dSixByM″z, M′ representing an element from the group V, Nb, Ta, Ti, Mo, W, Zr, Hf or a combination of these and M″ representing an element from the group C, P, Ge, As, Sb, In, O, N or a combination of these and the following conditions applying: a+b+c+d+x+y+z=100%, with a=100% −b−c−d−x−y−z, 0≦b≦15, 0,5≦c≦2, 0,1≦d≦6, 2≦x≦20, 2≦y≦18, 0≦z≦10 and x+y>18. The inventive transductor regulators are particularly advantageously used in motor vehicle voltage supplies, rail power supplies or in aircraft power supplies.

### DESCRIPTION

Half-cycle transductor with a magnetic core, use of half-cycle transductors and method for producing magnetic cores for half-cycle transductors.

The invention relates to a half-cycle transductor with a magnetic core, the deployment of half-cycle transductors as well as a method for producing magnetic cores for half-cycle transductors.

Switched power supply units using transductor regulators with clock frequencies between 20 kHz and 300 kHz are being progressively more deployed in ever more diversified applications as for instance in applications, which require voltages that are adjusted exactly to a maximum of power or currents despite quick load changes. They include e.g. switched power supply units for PCs or printers.

The basic principles of this type of transductor regulator including the corresponding half-cycle transductor and the related switched power supply units are described in detail in for instance DE 198 44 132 A1 or the VAC trade literature TB-410-1, 1988.

There basically exist two requirements for a transductor regulator:

First, the windings' resistance should be as minimal as possible in order to reduce winding losses. This can be achieved by reducing the winding rate while concurrently increasing the conductor's cross-section. At the same time, this effects an increased changeover rejection of the transductor's core material and thus the magnetic reversal losses. However, a significant reduction of the transductor core volumes and thus the component volumes can only be achieved if the specific losses of the transductor's core materials are considerably reduced, or if very high magnetic reversal losses are permitted due to extremely high upper application limit temperatures.

Secondly, the so-called induction excursion ΔB_{RS}=B_{S}−B_{R} of remanence B_{R} into saturation B_{S} should be as negligible as possible, as the induction excursion ΔB_{RS} signifies a tension-time area that cannot be regulated. The tension-time area, which is offered to the transductor for an adjustment to a maximum of power becomes increasingly smaller due to which a large tension-time area has an increasingly stronger effect due to ΔB_{RS}. Enlarging the core geometry or the core volume can compensate this. This could entail increased cyclic magnetization losses, however. Since transductor cores with a rectangular hysterisis cycle have particularly high remanence values, they are therefore particularly well suited for transductor regulators with higher operating frequencies. Such rectangular characteristics can be created if the transductor core material has a uniaxial anisotropy K_{U} parallel to the magnetic field H, which had been created by means of the core.

The demand for switched power supply units with increasingly smaller designs is met by the use of operating frequencies, which are increasingly higher. The switching frequencies now reach several 100 kHz predominantly in switched power supply units for PCs.

These rather high switching frequencies require transductor core materials having rather low cyclic magnetization losses. The permissible operating temperature and the long-term stability of transductor regulators are very much increased through enhancing the electronic component's packing density as well as the request for a rationalization of the fans' path. These requirements become particularly critical if the transductor regulator will be used in ambient temperatures exceeding 100° C., which for instance can occur in automobile or industrial applications. The upper limit used to be 130° C. so far.

Transductor regulators are known from DE 198 44 132 A1, which had been mentioned at the beginning. They feature magnetic cores consisting of nanocrystalline alloys. It is true that the transductor regulators described in DE 198 44 132 A1 are characterized by a excellent switch rule behavior based on their small induction excursion. However, due to high losses the alloy examples that are shown in the embodiment of the invention in connection with the heat treatments for transductor cores, which are described there, indicate that they have not been optimized for a deployment with high frequencies. The maximum possible cyclic magnetization losses are even accepted. Thus, the maximum possible operating frequencies are apparently limited to 150 kHz. Furthermore, excessive losses and noises, which are created due to magnetic elastic vibrancies, can be expected.

The task of the present invention thus consists in providing a half-cycle transducer having an excellent switching behavior with operating frequencies ranging from 10 kHz to 200 kHz or higher, while having minimal cyclic magnetization losses at the same time. Furthermore, the magnetic cores used should have a rather high aging stability up to temperatures of at least 150° C. or more, and they should have a rather small magnetic core volume.

The task is solved by means of a half-cycle transductor in accordance with claim 1, or a method for producing a magnetic core for a half-cycle transductor in accordance with one of the claims 7 or 8, or the use of such half-cycle transductor in accordance with claim 14. Designs and further developments of the inventive concept are subject to subordinate claims.

A half-cycle transductor having a magnetic core consisting of a nanocrystalline alloy, which is composed of FeₐCo_{b}Cu_{c}M′_{d}SiₓB_{y}M″_{z}, whereby M′ signifies an element from the group V, Nb, Ta, Ti, Mo, W, Zr, Hf or a combination thereof, and whereby M″ signifies an element from group C, P, Ge, As, Sb, In, O, N or a combination thereof, and a+b+c+d+x+y+z=100%, with a=100%−b−c−d−x−y−z; 0≦b≦15; 0.5≦c≦2; 0.1≦d≦6; 2≦x≦20; 2≦y≦18; 0≦z≦10 and x+y>18, has been provided in the invention. This alloy has a microcrystalline structure with a metallographical core of median size D<100 nm and a volumetric performance of over 30%, a hysterisis loop, which is as rectangular as possible having low cyclic magnetization losses at the same time, as well as a considerably reduced magnetic striction of |λ_{S}|<3 ppm following a heat treatment, which must be exactly adjusted to the respective compound. In addition, the saturation induction has a value of B_{S}=1.1 . . . 1.5 tesla, which is a value that cannot be obtained using other alloys that do not have that amount of magnetic striction. An additional advantage of this alloy system with a rectangular loop, which has been discovered as part of the examinations, which have been performed here, are particularly favorable in the exemplary embodiment of rather weak and almost linear temperature courses of the residual excursion and cyclic magnetization losses.

The alloy choice in accordance with the invention is based on the knowledge that a connection, which is similar to a hyperbola, exists between cyclic magnetization losses P_{fe} and the dynamic residual excursion ΔB_{RS} for certain alloy compounds.

This connection, which is similar to a hyperbola, is depicted in FIG. 1 using alloy Fe_{73.5}Cu₁Nb₃Si_{15.7}B_{6.8}.

The interaction of the cyclic magnetization losses P_{fe} on one side and the dynamic residual excursion ΔB_{RS} on the other side will be adjusted via a heat treatment in a magnetic longitudinal field. So-called longitudinal anisotropy K_{U} will be adjusted via such longitudinal field heat treatment, whereby ΔB_{RS} drops, while K_{U} increases and the losses increase. The interrelationship depicted in FIG. 1 will experience interferences from interfering anisotropies. The lower the longitudinal anisotropy the greater the influence from the interfering anisotropies.

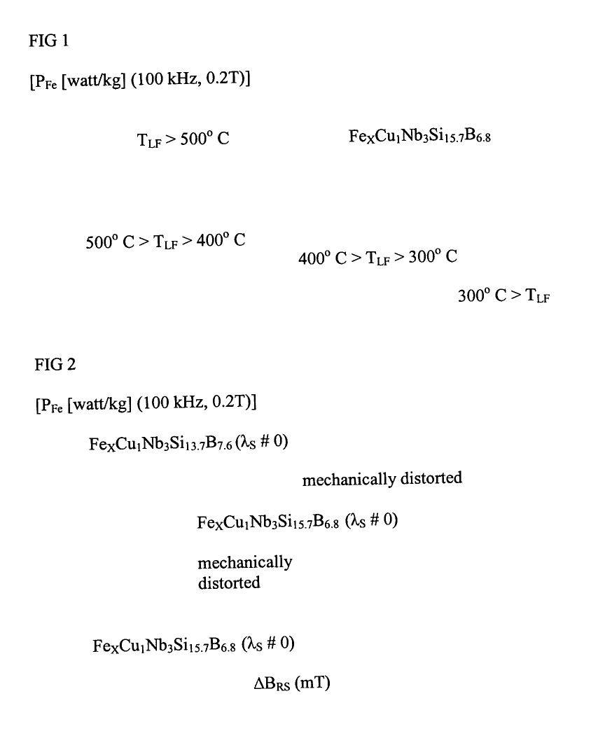

This is clearly visible in FIG. 2, which depicts the influence of mechanical restraints on magnetic cores of non-adjusted magnetic strictions.

The value of longitudinal anisotropy K_{U} must be limited to a reasonable minimum in accordance with the present invention, since the amount of total losses, which are composed of classic eddy current losses and abnormal eddy current losses, thus notably determining self-heating and the magnetic core's upper application limit temperature via its modulation capacity as well as size at certain operational frequencies.

The aging stability of the hysterisis characteristics reduces if the values of longitudinal anisotropy K_{U} are too low and/or the influence of the so-called magnetic elastic but also structural or interfering anisotropies, which come from the band's topology (surface roughness), increase considerably. Both interferences cause remanence B_{R} to decrease, thus causing an increase of residual excursion ΔB_{RS}, which is responsible for the dead time of the standard characteristic, whereby the static and dynamic coercive field strength increases in certain cases.

At the same time, we can fall back on the fact that the dynamic residual excursion ΔB_{RS} decreases as the frequencies increase. Nevertheless, when determining the K_{U} value, a well-balanced and production-stable compromise between preferably low P_{fe} losses on the one hand and preferably high remanences E_{R} on the other hand should be looked for, which is possible within the nanocrystalline alloys only when selecting the above listed alloy choice in accordance with the invention.

A compromise resulting from both of these values running in opposite directions can only be set expressly by means of a heat treatment (annealing), which is adapted to the alloy's characteristics in a magnetic field, which is running along the wound band, in other words, along a so-called longitudinal field. A very rectangular hysterisis loop, a so-called Z-loop, can thus be induced.

A sufficiently low residual excursion ΔB_{RS} can be obtained in a stable manner with a small induced uniaxial anisotropy K_{U}, if the magnetic elastic part of the anisotropy in the anisotropy balance is as low as possible and the frequency as high as possible, since the stability of such a Z-loop and the height of remanence B_{R} depends on the balance between interfering anisotropies on the one hand, and induced uniaxial anisotropy K_{U} on the other hand.

This is largely effected by the elimination of the saturation magnetic striction λ_{g}, of the mechanical tensions σ as well as crystal anisotropy K₁. The concurrent elimination of these three physical values, which are independent from each other, can also be effected by means of an optimized heat treatment for the alloy choice, which was listed above.

Particularly excellent characteristics with respect to the squareness of the hysterisis loop can be obtained while at the same time having only minimal cyclic magnetization losses in the magnetic cores and thus rather large modulation abilities of the transductor regulators, which were produced using theses magnetic cores, when the magnetic core has a magnetic striction value of |λ_{S}|<0.2 ppm and the alloy is composed of FeₐCo_{b}Cu_{c}M′_{d}SiₓB_{y}M″_{z}, whereby M′ signifies an element from the group V, Nb, Ta, Ti, Mo, W, Zr, Hf or a combination thereof, and whereby M″ signifies an element from the group C, P, Ge, As, Sb, In, U, N or a combination thereof, and a+b+c+d+x+y+z =100%, with the following conditions: 0≦b≦0.5; 0.8≦c≦1.2; 2≦d≦4; 14≦x≦17; 5≦y≦12 with 22≦x+y≦24.

Surprisingly, a feature of this alloy choice, which is an alloy choice of the nanocrystalline alloy choice, which had been mentioned at the beginning, is that a markedly rectangular hysterisis loop can be realized including an optimized heat treatment using the lowest values of a uniaxial longitudinal anisotropy, which typically exists in the range K_{U}<10 J/m³, due to the largest possible elimination of crystal anisotropy K₁ and the saturation magnetic striction λ_{S}.

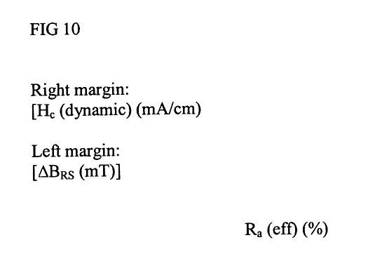

Particularly excellent residual excursion values ΔB_{RS}, which exist in the range of lower 0.025×B_{S}, can be obtained as long as the used alloy bands feature an effective roughness, which are within the ranges listed below. The roughnesses of the surfaces as well as the band thickness are important influential values for the magnetic characteristics. The effective roughness Rₐ (eff) is a significant influential value. Roughness Rₐ (eff) is defined as the sum of the roughnesses, which runs transversally to the direction of the band on the band's top side and the band's bottom side divided by the band's thickness. It is thus indicated in percent. Particularly excellent residual excursions can be obtained with the alloys, which consist of the alloys, which have been listed above, and which have roughnesses ranging from 3% to 9%, and preferably from 4% to 7%, which can be inferred from FIG. 10.

The processing of the alloy bands into magnetic cores largely occurs without tension by winding them onto special machines, which are known from prior art. Typically special care is taken with respect to the mechanic freedom from stress due to the heavy requirements with respect to low losses and a pronounced squareness of the hysterisis loop of the magnetic cores.

The alloy bands are subsequently wound into magnetic cores, which typically exist as closed ring cores without air gaps. The alloy band can initially be wound in a round manner to the ring core and shaped according to the requirements by means of suitable shaping tools during the heat treatment to produce these magnetic core forms.

The appropriate shape can already be obtained during the winding phase by using suitable winding bodies.

To avoid tensions when winding the alloy band to the magnetic core, attention is preferably paid to the tensile load of the alloy band, so that it continually decreases while the band layer amount increases. Is it thus achieved that the torque, which is tangentially affecting the magnetic core, will remain constant across the entire radius of the magnetic core and that it will not increase while the radius is growing.

Particularly small static and/or dynamic coercive field strengths and thus particularly favorable loss values are obtained while having a small residual excursion at the same time, when the alloy band is equipped with an electrically isolating layer at one surface at least. This causes an improved tension release of the magnetic core on the one hand, and particularly low eddy current losses are being obtained on the other hand.

The magnetically soft amorphous band, which was produced using the quick set technology, typically features a thickness of d<30 μm, preferably <20 μm, and better <17 μm.

An immersion, traversing, spray or electrolysis process is used at the band according to the requirements with respect to the quality of the insulation layer. The same can be obtained through an immersing insulation of the wound or stacked magnetic core. When selecting the insulating medium attention needs to be paid to it properly adhering to the band's surface and that it will not cause any surface reactions, which could lead to damaged magnetic characteristics. Oxides, acrylates, phosphates, silicates and chromates of the elements Ca, Mg, Al, Ti, Zr, Hf, Si have proven themselves as effective and compatible insulators for the alloys, which are used in accordance with the invention. Mg is particularly effective. It is being applied onto the band's surface as a liquid preliminary product containing magnesium. During a special heat treatment, which does not affect the alloy, it transforms itself into a thick layer of MgO with a thickness ranging between 50 nm and 1μm.

In order to adjust the nanocrystalline structure, magnetic cores and alloys, which are suitable for nanocrystallization, are generally subjected to an exactly adjusted crystallization heat treatment, which ranges from 450° C. to 690° C. according to the various alloy compounds. Typical dwell times range from 4 minutes to 8 hours.

This crystallization heat treatment is to be performed in a vacuum or in a passive or reducing blanket gas according to the alloy. Material-specific pureness conditions need to be adhered to in all cases, which can be brought about according to the specific cases by using the appropriate devices such as element-specific absorber or getter materials.

An exactly adjusted temperature and time combination is taken advantage of so that the alloy compounds used here exactly balance the magnetic striction contributions of the microcrystalline grain and the amorphous remaining phase thus creating the required magnetic striction variability of approximately |λ_{S}|<3 ppm, preferably |λ_{S}|<0.2 ppm.

Tempering takes place either field-free or in the magnetic field along the direction of the wound band (“longitudinal field”) or transversally to it (“transverse field”) according to the alloy and the embodiment of the magnetic core. A combination consisting of two or even three of these magnetic field constellations can be used in a time sequence or in a parallel manner in certain cases.

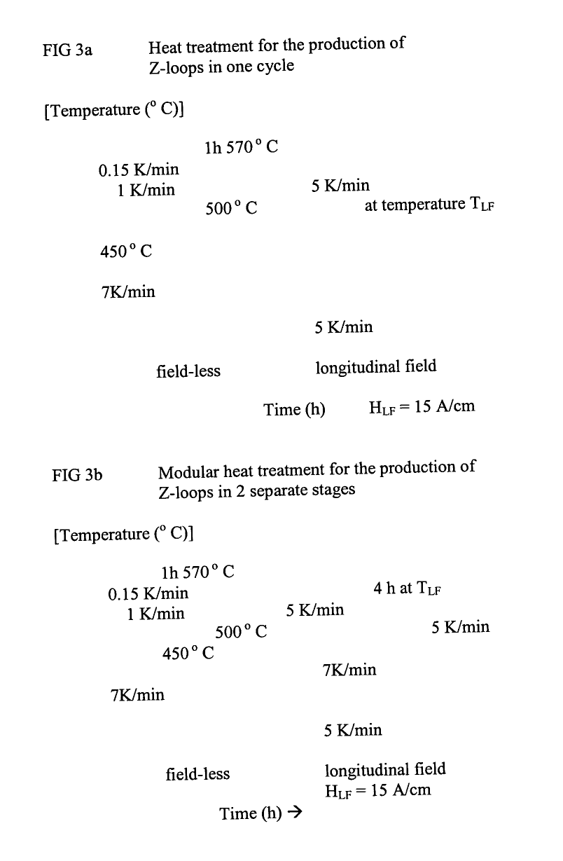

The temperature/time profile of a heat treatment, which is used for the alloy Fe_{73.5}Cu₁Nb₃Si_{15.7}B_{6.8} with which the adjustment of almost complete magnetic striction variability could be obtained, is depicted in FIG. 3a. The initial heating rate of 7 K/min shown in this figure can be varied in almost any way ranging from approximately 1 to an excess of 20 K/min. For economic reasons, a heating rate is selected in practical life, which is as high as possible, yet still feasible from a production-technological point of view.

The significant delay of the heating rate, which is shown starting at 450° C., and which is incidentally depending on the core's volume and which typically ranges approximately from 0.1 to approximately 1 K/min, serves as a temperature compensation of the nanocrystallization that was used there. Furthermore, a heating break of several minutes can be taken.

The nanocrystalline structure matures at a plateau of approx. 570° C. until the crystal grains reach a volumetric content in the amorphous remaining phase in which the magnetic striction has a “zero-crossing”. Fluctuations of the alloy's silicon content can be compensated through a variation of this maturation temperature.

Thus, for instance λ_{S}=0 is obtained with a silicon content of 15.7 atom % at approx. 570° C. This occurs at approx. 562° C. with a silicon content of 16.0 atom %, and at 556° C. with a silicon content of 16.5 atom %.

Higher silicon contents promote the band's embrittlement. The maturation temperature must be changed to 580° C. or higher in case of lower silicon contents, e.g. a content of 15.4 atom %, whereby however harmful iron boride phases develop, which increase the coercive field strength as well as the dynamic residual excursion ΔB_{RS} at the same time.

The range of the dwell time can be varied more or less widely according to the temperature situation. Typical intervals range from 15 minutes to 2 hours at 570° C. They can be extended at lower temperatures. A high degree of maturation of the nanocrystalline two-phase structure can be achieved with shorter times, e.g. a time of 5 minutes, at higher temperatures or for rather small magnetic cores.

The influence of cooling rates is rather minor, whereby constant and preferably high cooling rates are preferred. However, the prerequisite is a defined process of the cooling phase, which continues to remain the same. For instance, cooling rates ranging from approx. 1 K/min to approx. 20 K/min have proven to be suitable. Possible influences can be compensated by means of a minor correction of the longitudinal field temperature. This is mainly the case when the crystal heat treatment is performed in a set up magnetic transverse field, and not in a field-free condition. When using a set up magnetic transverse field during the crystallization pre-treatment, the longitudinal anisotropy K_{U} can be adjusted with great exactitude during the subsequent longitudinal field phase so that the dynamic residual excursion ΔB_{RS} and the cyclic magnetization losses P_{fe} can be adjusted most precisely. In addition, the possibility of diffusions during the annealing of the stacked magnetic cores is significantly reduced.

The uniaxial longitudinal anisotropy K_{U} is adjusted in the longitudinal field plateau. The size of the induced uniaxial longitudinal anisotropy could be adjusted over a wide range by means of the field temperature level but also the duration of the field heat treatment and the strength of the set up magnetic field as could be determined with the invention, upon which this is based. A high longitudinal field temperature T_{LP} leads to a large K_{U}, which means to small dynamic residual excursions ΔB_{RS}. A low longitudinal field temperature causes the opposite to occur. The exact interrelation can be deduced from FIG. 1, which had been mentioned at the beginning.

The influence of the holding period above certain times is rather minor while the temperature influencing K_{U} is heavily dependent on kinetics.

Furthermore, the level of K_{U} is being influenced by the strength of the longitudinal field, whereby K_{U} steadily increases together with the longitudinal field strength. The requirement for the production of a “good” rectangular Z-loop having a small coercive field strength and a high remanence at the same time is that the magnet core is magnetized while being tempered at every place until the point of saturation induction. Longitudinal field strengths of approx. 10 to approx. 20 A/cm are typical in this case, whereby field strength H, which is necessary to reach the saturation increases the more the geometrical quality of the deployed band is inhomogeneous. However, satisfying Z-loops can be obtained with longitudinal field strength of 5 A/cm or even less. Static remanences with respect to saturation ratios of B_{R}/B_{S}>60% exist in case of a disappearing longitudinal field, which rapidly increase with an increasing frequency. As a result, lower losses in combination with small residual excursions can be obtained with high frequencies in this case as well, e.g. 100 kHZ or more.

Part of the present invention is to perform two subsequent heat treatments. This is depicted in FIG. 3b, which shows two subsequent heat treatments and their effect analogously to the heat treatment, which is depicted in FIG. 3a. FIG. 3a and 3b both refer to the same alloy. The first heat treatment serves to form the actual nanocrystalline alloy having nanocrystalline grains of <100 nm and a volumetric performance of more than 30%. The second heat treatment occurs in the “longitudinal field”. This second heat treatment can take place at a lower temperature as the first heat treatment and serves to form the anisotropy axis along the band's direction. As an alternative thereto, a nanocrystalline alloy structure is initially formed in one and the same heat treatment and the anisotropy axis is subsequently induced along the direction of the alloy band (see FIG. 3a).

In addition thereto, the anisotropy area can also be expanded and fine-tuned using a well-defined sequence of a field-free treatment and/or a treatment in the field which is adapted to the respective alloy compound, and which at times can stand along the direction of the controlled band or transversally thereto.

The production of the nanocrystalline phase and the formation of the anisotropy axis can take place at the same time if special aging-stable rectangular loops with an almost ideal remanence, i.e. ΔB_{RS} are required. The magnetic core will be heated until it reached the targeted temperature for this purpose. It will he kept at that temperature until the nanocrystalline structure is formed, and it will subsequently be cooled until it reaches ambient temperature. The longitudinal field is either set up during the entire heat treatment or only after reaching the target temperature, or it can even be activated at a later point in time according to the targeted level of the longitudinal anisotropy. High K_{U} values are obtained altogether when using this type of field heat treatment, which lead to comparatively large ratios of abnormal eddy current losses, which is why transductors, which were made in such manner are preferably suitable for lower frequencies.

The heating up to the target temperature occurs as quickly as possible, e.g. with a rate ranging from 1° C./min to 15° C./min.

A delayed heating rate of less than 1° C./min or even a “temperature plateau” lasting several minutes can be introduced to obtain an internal temperature compensation in the magnetic core, but also a particularly fine and dense core structure in and/or below the temperature range of the starting crystallization, i.e. below the crystallization temperature, starting at 460° C. for instance.

The magnetic core will for instance be kept between 4 minutes and 8 hours at the target temperature around 550° C. in order to obtain a grain which is as small as possible having a homogenous grain size distribution and small intergranular distances. The lower the alloy's silicon content, the higher the temperature selected. For example, the beginnings of a formation of non-magnetic iron-boride phases or the growth of surface crystallites on the band's surface constitute the upper limit for the target temperature.

The magnetic core will then be held between 3.1 and 8 hours below Curie temperature T_{C}, i.e. e.g. between 260° C. and 590° C. with an actuated longitudinal magnetic field to adjust the anisotropy axis and thus the hysterisis loop, which is as rectangular as possible. Uniaxial anisotropy K_{U} along the band's direction, which was induced in this connection, increases the higher the temperature level in the longitudinal field is selected. The residual excursion ΔB_{RS} continually decreases due to the increased remanence so that the highest values are created at the lowest temperatures. The cyclic magnetization losses increase inversely. The magnetic core is subsequently being cooled between 0.1° C./min and 20° C./min to ambient temperature near temperatures of e.g. 25° C. or 50° C. in the adjacent longitudinal field. On the one hand this is advantageous for economical reasons, and, on the other hand, for reasons of the hysterisis loop's stability, no field-free cooling may take place below the Curie temperature.

The field strength of the magnetic field, the longitudinal field, which was set up in the direction of the wound alloy band, was selected in such manner, that it is significantly larger than the field strength, which is required to reach saturation induction B_{S} in this direction of the magnetic core. For instance, excellent results could already be obtained using magnetic fields H>0.9 kA/m, whereby it became known here that the induced anisotropy continually increases with the longitudinal field.

The magnetic core is solidified following the heat treatment. According to the available volume, thermal conditions or mechanical stress susceptibility would for instance provide by means of impregnation, coating or covering using suitable plastic materials such as hard epoxy layers or soft xylilene layer and subsequently encapsulate it. Transductor cores, which were produced in this manner, can be equipped with at least one winding, respectively. The deployment of soft and volume-saving fasteners will be enabled despite heavy wire strengths by means of a magnetic striction freedom, which exists to a large degree, of the alloy areas, which had been indicated as being preferred.

The invention shall be discussed in detail below from several embodiments. The various heat treatments, which are discussed in the embodiments, will be illustrated by means of the attached figures.

### FIRST EMBODIMENT

Particularly excellent physical results were obtained using a magnetic core, which was wound tension-free, with the dimensions 30×20×10 mm³ from the alloy Fe_{73.42}Cu_{0.99}Nb_{2.98}Si_{15.76}B_{6.85}, whereby the effective roughness Rₐ (eff) of surface was 4.5%. The mean band thickness was 20.7 μm.

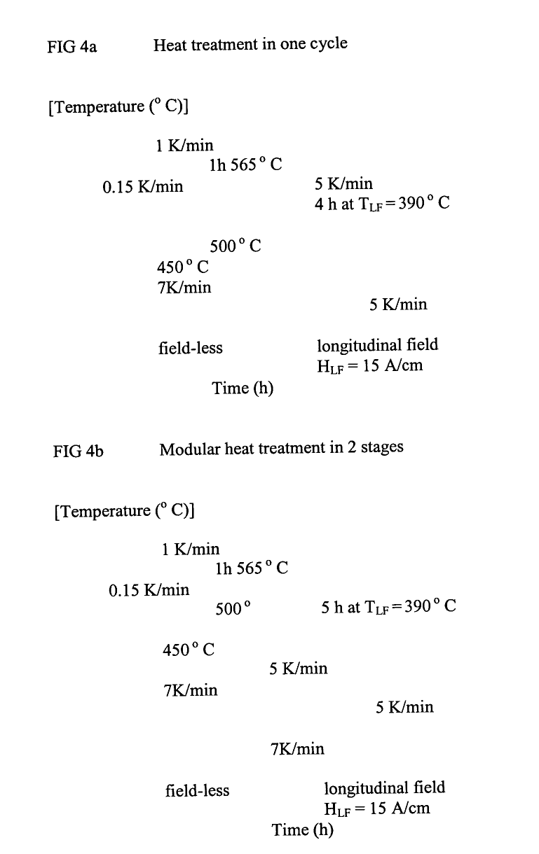

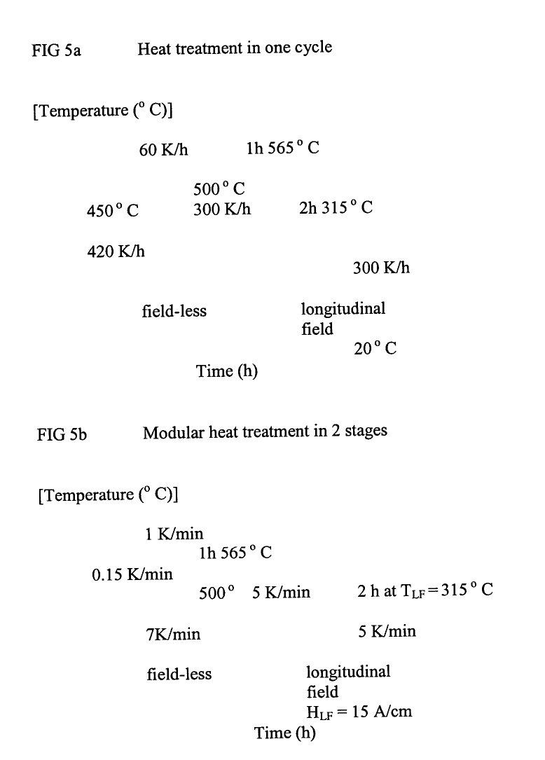

FIGS. 4a and 4b show the temperature/time profile of the deployed heat treatments. The magnetic cores were initially heated to a temperature of approx. 450° C. using a heating rate of 7 K/min. No magnetic field had been set up. The heating rate was subsequently delayed to approx. 0.15 K/min in order to avoid an undefined overheating of the magnetic core due to an exothermal heat development during the nanocrystallization process, which begins at that point. It was heated up to a temperature of approximately 500° C. using this relatively low heating rate of 0.15 K/min. Using a heating rate of 1 K/min it was heated to a final temperature plateau of 565° C.

The magnetic core was kept at this temperature of 565° C. for approx. 1 hour. The alloy structure matured at this temperature plateau until the crystalline grains had reached a volumetric share in the amorphous alloy matrix in which the magnetic striction had almost disappeared. A subsequent cooling took place to a temperature of approx. 390° C. using a cooling rate of approx. 5 K/min. A magnetic longitudinal field H_{LF} of approx. 15 A/cm was enabled. The magnetic core was left for 5 hours at this temperature in this so-called longitudinal field plateau. This set the uniaxial longitudinal anisotropy K_{U}. The magnetic core was subsequently cooled to ambient temperature using a cooling rate of 5 K/min. FIG. 4b depicts the heat treatment in a “modular” manner, which was just discussed, i.e. the field-less crystallization treatment and the heat treatment in the magnetic longitudinal field were divided with respect to time, whereby the magnetic core was cooled to ambient temperature following the crystallization heat treatment.

The magnetic core showed magnetic striction λS=0.12 ppm after the 60 minute heat treatment at a temperature of approx. 565° C., which virtually means freedom of magnetic striction. A longitudinal anisotropy, which occurred after a subsequent five hour treatment at T_{LP}=390° C. in a longitudinal field with a strength of 1.5 kA/m, caused an inductive residual excursion ΔB_{RS}=63 mT having cyclic magnetization losses of P_{fe}=85 watt/kg (measured using a frequency of 50 kHz and a magnetic field of 0.4 T).

The magnetic core's magnetic values deteriorated due to its almost perfectly adjusted magnetic striction and an insulation using magnesium oxide, which was unilaterally applied to the band's bottom part, but they did not deteriorate following a coating using a volume-saving and heat eliminating fluidized epoxy bed. This magnetic core was wound using a copper wire with a strength of 4×0.8 mm using 6 windings.

A combinational power supply unit, which was clocked at 120 kHz with a 275 watt output showed a completely stable output voltage at the transductor-regulated 3.3 volt output in this transductor element with a maximum taking up of power of 150 watt of the directly regulated 5 volt output.

A somewhat smaller, but otherwise identical magnetic core having the dimension 20×12.5×8 was installed in said switched power supply unit under a 20-watt load at the 3.3 volt output. However, the magnetic core in the transductor overheated excessively since it was driven to full output too powerfully through the tension/time area, which was too high, due to its iron cross-section, which was reduced by the factor 1.7. Thus, the switched power supply unit was not able to function at full capacity.

### SECOND EMBODIMENT

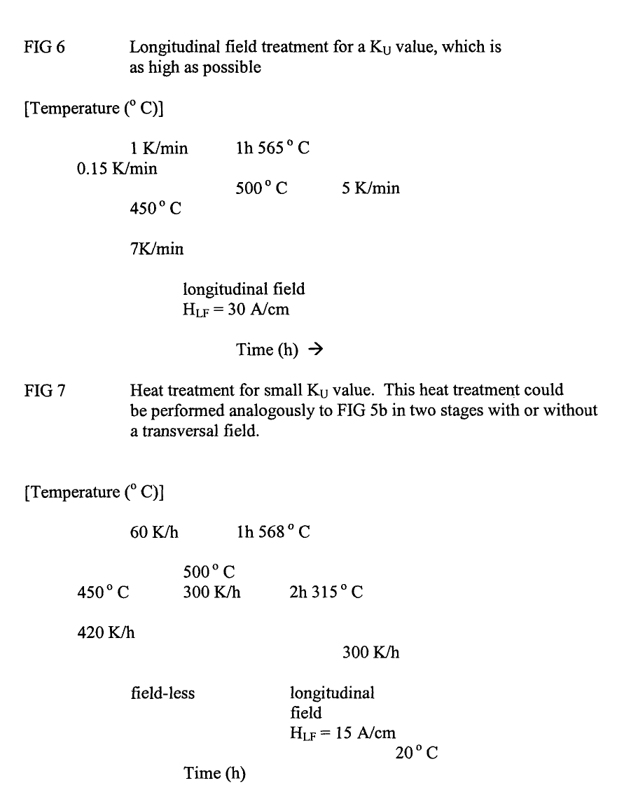

A magnetic core consisting of the same alloy compound and the same dimensions as in the first embodiment, and which was wound tension-free was used. However, a reduced longitudinal field temperature of approx. 315° C. was used to lower the cyclic magnetization losses P_{fe} for a shorter time of 2 hours. This heat treatment is shown in FIG. 5a. FIG. 5b shows the same heat treatment in modular form the main features of which were discussed in the first embodiment.

The cyclic magnetization losses P_{fe}, which resulted from a dwell time that had been reduced to 2 hours, and a lowered longitudinal field temperature of approx. 315° C. were only at 62 watt/kg at this point. The dynamic residual excursion ΔB_{RS}, however, was increased to 137 mT. The transductor regulator's dead time, which is related thereto, was excessive thereafter, which is why the output voltage of 3.3 volt power supply unit output collapsed under a load of 10 watts while the 5 volt output, which was directly regulated and almost coasted.

### THIRD EMBODIMENT

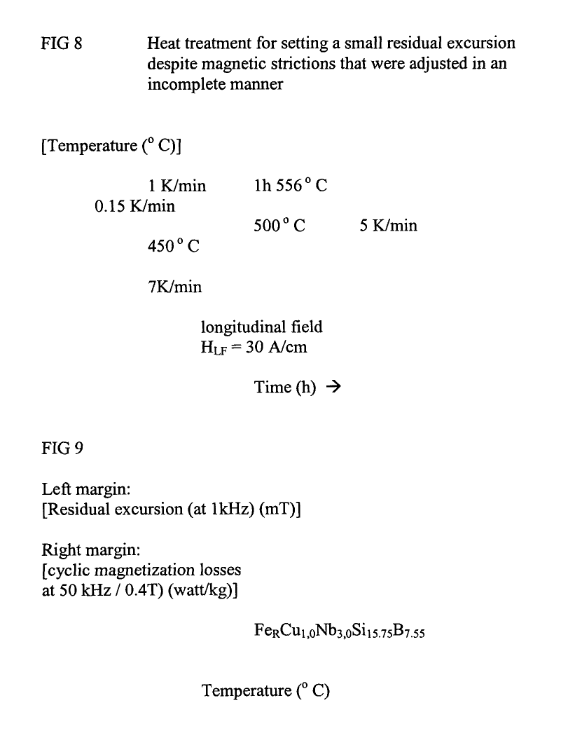

The use of power barrier diodes including an increased recovery current during the transition into the locked direction enabled a well-defined increase of the coercive field strength of transductor regulators. A magnetic core consisting of the identical alloy compound as in the first embodiment and having the same dimensions was tempered to the maximum longitudinal anisotropy K_{U} using a single phase heat treatment at a temperature of approx. 575° C. in a magnetic longitudinal field with a strength of H_{LF}=30 A/cm. Thus, a very small residual excursion ΔB_{RS}=25 mT was obtained, whereas the cyclic magnetization losses P_{fe} increased up to 160 watt/kg at 50 kHz/0.4 T. To reduce the modulation while maintaining the tension/time area, the transductor core had to be enlarged to a dimension of 30×20×17 mm³ due to the excessive cyclic magnetization losses. The heat treatment, which was applied, is depicted in FIG. 6. However, independent of the recovery effect, such transductor types having a high longitudinal anisotropy and a small residual excursion, are very well suited for a deployment at frequencies, which are barely above the audibility range, as they occur for instance in decentralized board power supplies (and frequently as auxiliary operational converters). Transductor-regulated power supply units, of which larger quantities are required, and which can be diverted from the main power supply, are thinkable for e.g. modem railway technology, but above all, in airplanes. In these cases, the relatively high saturation induction of nanocrystalline alloys of an excess of 1.1 T is a great advantage, as the high modulation capacity allows for a reduction of the iron cross-section and thus of the core's weight. In addition, this advantage increases due to the fact that the core can be equipped with a epoxy layer, which eliminates heat very well. Ultimately, this is only possible due to the very small level of magnetic saturation restriction without the residual excursion increasing in a noteworthy manner. Moreover, the favorable course of temperatures of the alloy system, which is depicted in FIG. 9, is advantageous above all in power supply units on board of airplanes, which are exposed to severe and quick temperature changes.

### FOURTH EMBODIMENT

A 30×20×10 mm³ magnetic core, which was wound tension-free, consisting of an alloy Fe_{73.31}CU_{0.99}Nb_{2.98}Si_{15.82}B_{6.90} with a roughness of Rₐ (eff) at 7.8% volume-optimized transductor regulator having only minimal cyclic magnetization losses for a deployment with rather high clock frequencies, as they can be typically encountered in switched PC power supply units. The median bandwidth was at 16.9 μm.

The cyclic magnetization losses P_{fe} at 50 kHz/0.4 T were comparatively low—they were at 55 watt/kg—due to the relatively high effective roughness and the band's minor thickness, which made the magnetic core applicable even at a high clock frequency of 200 kHz or more. However, the small uniaxial anisotropy K_{U} caused certain tension sensitivity despite an existing and almost complete magnetic striction freedom. This required a protective trough inside the case, which was associated with geometric and thermal disadvantages.

### FIFTH EMBODIMENT

Due to the excellent producibility of the alloy Fe_{74.4}Co_{1.1}Cu₁Nb₃Si_{12.5}B₈ and the related very low effective roughnesses tension-free wound magnetic cores were produced from this alloy with the dimensions 30×20×10 mm³. The thus obtained roughness Rₐ (eff) of the band's surface was 2.2%. The median bandwidth was 23.4 μm.

The magnetic saturation striction λ_{S}, which existed after the crystallization heat treatment at 556° C. was approx. 3.7 ppm, and was therefore adjusted in an incomplete manner. To set a maximum uniaxial anisotropy K_{U} value, the magnetic core was tempered at this temperature as well in the longitudinal field in order to obtain small residual excursion values ΔB_{RS}.

The result was a very low residual ΔB_{RS} excursion of 23 mT as well as cyclic magnetization losses P_{fe} of 220 watt/kg at 50 kHz/0.4 T.

Moreover, excessive cyclic magnetization losses occurred at frequencies around 30 kHz and around 120 kHz, which could be traced back to magnetic-elastic resonance effects. Any magnetic cores, which were produced in this manner, can only be used for comparatively low frequencies, which exist outside of these magnetic-elastic resonances. An overheating of the transductors would take place causing the destruction of the transductor regulators if other operating conditions were used under these conditions.

### SIXTH EMBODIMENT

Five magnetic cores consisting of the alloy Fe_{74.5}Cu₁Nb₃Si_{14.5}B₇ were produced analogously to the first embodiment and as in the fifth embodiment. The magnetic saturation striction λ_{S} was approx. 1.8 ppm here. The magnetic core was enveloped with fast hardening plastic so that a mechanic tension could be induced. This leads to an increased dynamic residual excursion ΔB_{RS} at frequencies of <100 kHz. A residual excursion of approx. 128 mT resulted at a frequency of approx. 10 kHz. The dynamic residual excursion was only marginally increased at frequencies exceeding 100 kHz when compared to the magnetic core from the first embodiment. The same characteristic resulted particularly after the installation into the switched power supply unit from the first embodiment.

A particularly innovative deployment of transductor regulators in accordance with the present invention is in power supply units for the board networks of motor vehicles in which the board network was converted to 42 volts. These board networks generally have different voltages. In one application 12 volt/500 watt from the 42 volt/3 kilowatt supply were realized via a transductor-regulated circuit. The output was permanently short-circuit proof at an operating frequency of 50 kHz and an ambient temperature of 85° C. in the motor of an internal combustion engine. A magnetic core with the dimensions 40×25×20 mm³ was used in which the plastic trough was equipped with 18 windings. It was an open design having a taping consisting of a 3×1.3 mm magnetic wire.

New drive concepts are using electric drives to make electricity. For instance, fuel cells have been under discussion for a while already. Generally water-cooled cooling-elements are used here, as the fuel cells need to be kept at approx. 60° C. to obtain an optimal degree of efficiency. These cooling systems can also be co-used for the 12 volt/42 volt supplies to reduce the weight or the construction volume. For this, a magnetic core with the dimensions 38×28×15 mm³ and an excellent heat-eliminating hard epoxy sheath was used in a power supply unit having the data that were already mentioned. The magnetic core was equipped with 46 windings consisting of 2×1.3 mm magnet wire and inserted into an aluminum case. The magnetic core was equipped with an epoxy grout with good heat-eliminating qualities in the aluminum case. An excellent cooling element connection could be obtained by means of this casing/grout combination, which, however, was only made possible by means of the magnetic core in accordance with the invention, which was almost free from magnetic striction.

The attached three dimensioning examples in table form are rendering the typical dimensioning of the transductor regulators in accordance with the invention from the alloy from embodiments 1 and 2 for the discussed application circuitry. Switched computer power supply units, i.e. switched PC power supply units as well as switched server power supply units were looked at with special attention. In practice, they are generally built as single-phase flow circuits with switching frequencies ranging from 70 to 200 kHz.

Example no. 1: transductor-regulated, short-circuit proof secondary voltage U1 of a switched PC power supply unit, f=150 kHz, ambient temperature: 45° C., i.e. maximum excess temperature of the transductor regulator=75 K. The maximum pulse-duty factor τ=0.5, minimum transducer output voltage: 24 V.

| Capacity | U₂ | I₁ | Magnetic core | N | d_{cu} |
|---|---|---|---|---|---|
| P = 20 W | 3.3 V | 6 A | 10 × 7 × 4.5 mm | 13 | 0.80 mm |
| | | | (M_{FE} = 1.06 g) | | |
| P = 33 W | 3.3 V | 10 A | 12.5 × 10 × 5 mm | 13 | 2 × 0.80 mm |
| | | | (M_{FE} = 1.30 g) | | |
| P = 75 W | 5 V | 15 A | 16 × 12.5 × 6 mm | 15 | 3 × 0.80 mm |
| | | | (M_{FE} = 2.76 g) | | |

Example no. 2: transductor-regulated short-circuit proof output voltage of a switched server power supply unit, f=100 kHz, ambient temperature 60° C., maximum pulse-duty factor τ=0.3, minimum transducer output voltage: 23 V. 2 solutions were realized:

| Capacity | U₁ | I₁ | Magnetic core | N | d_{cu} |
|---|---|---|---|---|---|
| P = 100 W | 3.3 V | 30 A | 16 × 10 × 6 mm | 6 | 4 × 0.80 mm |
| | | | (M_{FE} = 4.32 g) | | |
| P = 100 W | 3.3 V | 30 A | 16 × 12.5 × 6 mm | 8 | 4 × 0.90 mm |
| | | | (M_{FE} = 2.76 g) | | |

Example no. 3: transductor-regulated short-circuit proof output voltage of a switched power supply unit, f=50 kHz, ambient temperature 45° C., maximum pulse-duty factor τ=0.5, minimum transducer output voltage: 40 V.

| Capacity | U₁ | I₁ | Magnetic core | N | d_{cu} |
|---|---|---|---|---|---|
| P = 220 W | 12 V | 18 A | 19 × 15 × 10 mm | 16 | 3 × 0.85 mm |
| | | | (M_{FE} = 6.3 g) | | |
| P = 380 W | 12 V | 32 A | 25 × 20 × 10 mm | 16 | 5 × 0.90 mm |
| | | | (M_{FE} = 10.4 g) | | |
| P = 500 W | 12 V | 42 A | 30 × 20 × 10 mm | 12 | 8 × 0.80 mm |
| | | | (M_{FE} = 23.1 g) | | |

A volume-optimized half-cycle transductor was created in accordance with the invention, which has low losses and a high saturation induction. When producing the magnetic core for a transductor the treatments for the transverse field and/or the longitudinal field are selectively used as part of the heat treatment to adjust the functional connection between cyclic magnetization losses and the dynamic residual excursion in a dosage and combination, which was optimally adjusted to the application.

The focal point is a control according to the amount of the uniaxial longitudinal isotropy with the help of a variation of the longitudinal temperature and/or an elegant combination consisting of the transversal field and longitudinal field treatment.

After a heat treatment, which will have to be exactly adjusted to the respective compound, an alloy, on which the magnetic core is based, has a microcrystalline structure with a metallographical core of for instance medium size D<100 nm and a volumetric performance of for instance an excess of 30%, a hysterisis loop, which will be as rectangular as possible, and concurrent low cyclic magnetization losses compared to a non-tempered condition, as well as a strongly reduced magnetic striction of |λ_{S}|<3 ppm. Moreover, the saturation induction has a value of e.g. B_{S}=1.1 . . . 1.5 tesla (T), which cannot be obtained with other alloys, which are low in magnetic striction.

An additional advantage of the present invention is the extremely weak and almost linear temperature reductions of the residual excursion and cyclic magnetization losses in this alloy system, an example of which is depicted in FIG. 9. Here, the negative temperature reduction of the cyclic magnetization losses is particularly favorable.

The excellent temperature and aging characteristics of cores, which were produced in this manner, allow a deployment of up to 160° C., as only minor losses occur initially, so that stronger aging can be accepted. This is contrary to the opinion, which was prevailing so far, and which generally assumed an upper application limit temperature of a maximum of 130° C. for nanocrystalline alloys. For instance, a conventional transductor core, which is shown in FIG. 1, having a frequency of 100 kHz and a modulation of B_{MAX}=0.02 T, can have losses of P_{fe}>140 watt/kg. An additional loss increase as a result of ageing cannot be accepted any more in this case.

An application of such cores is made possible in transductors in general and in transductors used for an application under high operating temperatures in particular due to the a priori small losses in the present invention and thus a higher application limit temperature. Thus, for instance, transductor regulators can be realized, which are deployed in motor vehicles or industrial drives, and thus are for example affixed to the motor as part of a motor control unit. The operating temperatures are generally definitely higher due to the immediate proximity to the motor and the complete encapsulation of the motor control unit as the operating limit temperature of the cores, which were known so far, would allow. A preferred method consists in the winding of the transductor core with an electrical conductor, which is being constructed with an appropriate temperature index in accordance with DIN 172.

1. Half-cycle transductor having a magnetic core made form a nanocrystalline alloy,
whereby the alloy is composed of FeₐCo_{b}Cu_{c}M′_{d}SiₓB_{y}M″_{z}, and M′ signifies an element from the group V, Nb, Ta, Ti, Mo, W, Zr, Hf or a combination thereof, and whereby M″ signifies an element from group C, P, Ge, As, Sb, In, O, N or a combination thereof, and where the following conditions shall apply: a+b+c+d+x+y+z=100%, with a=100%−b−c−d−x−y−z; 0≦b≦15; 0.5≦c≦2; 0.1≦d≦6; 2≦x≦20; 2≦y≦18; 0≦z≦10 and x+y>18;
and in which the magnetic core has a hysterisis loop, which is as rectangular as possible as well as magnetic saturation striction |λ_{S}|<3 ppm.

2. Half-cycle transductor in accordance with claim 1, characterized by the following conditions being applicable:
0≦b≦0.5; 0.8≦c≦1.2; 2≦d≦4; 14≦x≦17, 5≦y≦12 with 22≦x+y≦24.

3. Half-cycle transductor in accordance with claim 1 or 2, characterized by the magnetic saturation striction being |λ_{S}<0.2 ppm.

4. Half-cycle transductor in accordance with one of the claims 1 through 3, characterized by the effective roughness Rₐ (eff) ranging from 3 to 9%.

5. Half-cycle transductor in accordance with claim 4, characterized by the effective roughness Rₐ (eff) ranging from 4 to 7%.

6. Half-cycle transductor in accordance with one of the claims 1 through 5, characterized by losses (P_{fe}) of lesser 140 watt/kg at a frequency of approx. 100 kHz and an induction amplitude of approx. 0.2 T.

7. Method for producing a magnetic core for a half-cycle transductor in accordance with one of the claims 1 through 6 including the following steps:
Pouring of a thin band consisting of an amorphous alloy;
Tension-free winding of the thin band to a magnetic core;
Heating of the magnetic core to an initial targeted temperature, which is above the crystallization temperature of the amorphous alloy, using a heating rate ranging from 1 K/min to 20 K/min;
Keeping the magnetic core at the first targeted temperature for a duration of 8 hours or less;
Cooling the magnetic core to a second targeted temperature, which is below the Curie temperature of the alloy and below the crystallization temperature of the amorphous alloy, with a cooling rate ranging from 1 K/min to 20 K/min;
Keeping the magnetic core at the second targeted temperature for a duration of 8 hours or less under magnetic longitudinal field H>0.5 kA/m;
Cooling the magnetic core to ambient temperature;

8. Method for producing a magnetic core for a half-cycle transductor in accordance with one of the claims 1 through 6 including the following steps:
Pouring of a thin band consisting of an amorphous alloy;
Tension-free winding of the thin band to a magnetic core;
Heating of the magnetic core to an initial targeted temperature, which is above the crystallization temperature of the amorphous alloy, using a heating rate ranging from 1 K/min to 20 K/min;
Keeping the magnetic core at the first targeted temperature for a duration of 8 hours or less;
Cooling the magnetic core to ambient temperature;
Heating the magnetic core to a second targeted temperature, which is below the Curie temperature of the alloy and below the crystallization temperature of the amorphous alloy, with a cooling rate ranging from 1 K/min to 20 K/min;
Keeping the magnetic core at the second targeted temperature for a duration of 8 hours or less under magnetic longitudinal field H>0.5 kA/m;
Cooling the magnetic core to ambient temperature;

9. Method for producing a magnetic core in accordance with claim 7 or 8, characterized by the second targeted temperature ranging from 290° C. to 520° C.

10. Method in accordance with claim 7, characterized by the entire heat treatment being performed in a field-free manner.

11. Method in accordance with claim 7, 8 or 9, characterized by the heating up to the initial targeted temperature being performed in a magnetic transverse field.

12. Method in accordance with claim 11, characterized by the hold plateau and/or the subsequent cooling phase taking place in a magnetic transverse field.

13. Process in accordance with one of the claims 7 through 11, characterized by the heating up to the initial target temperature taking place up to a temperature of approx. 450° C. with a heating rate ranging from 1 K/min to 20 K/min and subsequently with a heating rate of approx. 0.15 K/min.

14. Use of a half-cycle transductor having a magnetic core in accordance with one of the claims 1 through 11 in a switched power supply unit in a motor vehicle power supply system.
